(19) United States
(12) Patent Application Publication
(10) Pub. No.: US 2026/0160157 A1
(43) Pub. Date: Jun. 11, 2026

(54) Hot-Swap System for a Hydraulic Fracturing System

(71) Applicant: Batfer Investment S.A., Montevideo (UY)

(72) Inventors: Adrian Bucciarelli, Buenos Aires (AR); Mario Ariel Vanzino, Buenos Aires (AR)

(21) Appl. No.: 19/371,590

(22) Filed: Oct. 28, 2025

(30) Foreign Application Priority Data
Dec. 9, 2024 (AR) P2024103383

(51) Int. Cl. E21B 43/26; F04B 15/02; F04B 17/06; F04B 53/22

(52) U.S. Cl. CPC E21B 43/2607; F04B 53/22; F04B 15/02; F04B 17/06

(57) ABSTRACT

A hot-swap system for quickly connecting pump trucks to missiles includes a missile having a high-pressure line with at least one connection pin, and a low-pressure line with at least one connection pin. At least one fracturing pump is connected in fluid communication to the high-pressure line by at least one automatic connector and to the low-pressure line by at least one automatic connector. The automatic connectors are configured to be connected to said at least one respective connection pin. The automatic connectors can be mounted on a pump truck.

### CROSS REFERENCE TO RELATED APPLICATION

This application claims priority to Argentine Application No. P2024103383 filed on Dec. 9, 2024, the disclosure of which is incorporated herein by reference for all purposes.

### TECHNICAL FIELD OF THE INVENTION

The present invention generally refers to oil and gas hydraulic fracturing operations and, more particularly, to a hydraulic fracturing system including a hot-swap fracturing pump system (HSS) designed to facilitate the replacement of fracturing pumps in a fracturing assembly without the need for personnel to enter the hazardous area.

### BACKGROUND OF THE INVENTION

Generally, hydraulic fracturing, or “fracking,” allows oil and natural gas to be produced from wells traditionally considered non-producing sites. The process of hydraulic fracturing involves injecting water at high pressure deep into the ground to crack the rock in the producing zone of the well, allowing oil or natural gas to flow through the cracks produced, recovering fluids where such possibility did not exist before. On average, a hydraulic fracturing process takes a few days to complete on a well, and once completed, the well is ready to produce oil and natural gas for years to come.

Fracking operations typically involve injecting millions of gallons of water containing sand or other particles and additives at high pressure into the depths and widths of horizontally drilled wells more than 9,800 ft below the surface level. The pressurized mixture of water, particles, and additives causes the rock of the ground formation to open up by forming microcracks. These microcracks are kept open by the presence of sand particles from the fracturing fluid that remain in them and this allows oil and gas to flow through the rock and into the wellbore and then, be extracted by a suitable pumping system.

A typical hydraulic fracturing system includes a plurality of hydraulic fracturing pumps configured to receive a mixture of fluids from a low-pressure inlet line and introduce them under pressure to a high-pressure discharge outlet. Said low-pressure inlet lines and high-pressure discharge lines are connected to a main manifold or missile. Missiles are intended to multiply the discharge of a plurality of bombs. The missile comprises a missile body and inlet assemblies. The missile body has a primary port and a plurality of feed ports. The primary port extends axially through the missile body. The feed ports extend radially through the missile body. Each feed port is associated with an inlet assembly. The inlet assembly comprises a connector which is releasably coupled to the missile body.

Fracturing pumps are typically mounted on vehicles for easy transportation, installation, and replacement. Such vehicles, typically referred to as “pump trucks,” receive fracturing fluids from a blender that is typically in fluid communication with a plurality of fluid sources, typically comprising water, acids, additives, and particles, for example, sand, clays, etc., of a given particle size distribution.

Additionally, a mixing unit may be provided in communication with a plurality of additive supply tanks, a plurality of water supply tanks, a plurality of acid supply tanks, and a plurality of particle supply tanks, such as natural or synthetic sand, clays, or other particles. Particles used to keep the downhole fractures open may be transported from the plurality of particle tanks to the mixing unit by suitable transportation means.

Each pump truck is in fluid communication with a missile through a plurality of high-pressure connections. The manifold or missile communicates the high-pressure fluids to the well.

In this typical system, maintenance or repairs to the fracking pump truck are performed at the end of the fracturing stage, since performing repairs or maintenance in the high-pressure zone or hazardous area near the trucks and missile is prohibited for safety reasons given the high pressures involved in the fracking operation. This presents challenges for connection operations of hydraulic fracturing pumps to the missile, as a failure in a pump truck has the potential to halt the entire operation because repairs are not allowed while the system is operational, i.e. pressurized.

In the event of a pump failure, some systems can be configured to continue operating with reduced pump power; however, this results in a loss of fracture process efficiency, which in turn leads to increased associated costs due to the extended transition times from one well to another as pump trucks are removed from the well site for repairs. This configuration implies increasing the personnel assigned to repair and maintenance operations during non-operational periods, since multiple pump repairs may be necessary at the same time. Therefore, the inability to repair fracturing pump trucks while in line, without the need to stop pumping operations, often leads to the operation of fracturing pumps until the moment they fail.

Therefore, there is a need in the prior art for a hydraulic fracturing pump system that allows the removal and replacement of a hydraulic fracturing pump truck while the hydraulic fracturing system is under normal operating conditions, i.e. under pressurized conditions.

In this regard, the prior art provides some solutions to the technical problem posed. For example, patent application US 2022/0098964, incorporated herein by reference, discloses a method, apparatus and system comprising an exchange adapter that is connected to an exchange station while a discharge manifold is pressurized by at least a first fracturing pump, said discharge manifold being adapted to communicate pressurized fluid to an oil and gas well. The exchange adapter is connected to a second fracturing pump via a first suction duct and a first discharge duct. The exchange station is connected to a suction manifold via a second suction duct. The exchange station is connected to the discharge manifold via a second discharge duct. After connecting the exchange adapter to the exchange station, and while the discharge manifold remains pressurized by at least the first fracturing pump, fluid is drawn from the suction manifold using the second fracturing pump; and pressurized fluid is discharged into the discharge manifold using the second fracturing pump. However, the disclosed exchange station has a complex design and requires precise positioning for the connection thereof to the exchange adapter installed on a pump truck, which can lead to a failed connection, thereby increasing operation time. Another drawback of the system described in the aforementioned patent is that said system requires personnel to enter the connection area, which is also a hazardous zone, in order to clean the adapters prior to reconnection. This makes the system inefficient when it comes to reducing personnel in said the hazardous area.

Therefore, the present invention provides a hot-swap system for a hydraulic fracturing system that solves these problems and others that will become apparent through the following detailed description of the invention.

### BRIEF DESCRIPTION OF THE FIGURES

FIG. 1 shows a schematic view of a hydraulic fracturing installation where a plurality of pump trucks is shown connected to a main missile.

FIG. 2 shows a schematic view of a hydraulic fracturing installation according to the present invention.

FIG. 3 shows a perspective view of a hot-swap system including a connector on a main missile or manifold according to the present invention.

FIG. 4 shows a front view of a hot-swap system, including a connector on a connection pin of a main missile or manifold according to the present invention.

FIG. 5 shows a top view of a hot-swap system including a connector on a main missile or manifold in accordance with the present invention.

FIG. 6 shows a perspective view of a main missile or manifold.

FIG. 7 shows a front view of the main missile or manifold.

FIG. 8 shows a perspective view of a connector of the hot-swap system in accordance with the present invention hanging from a support structure mounted on a pump truck.

FIG. 9 shows a front view of the connector of the hot-swap system according to the present invention hanging from a support structure mounted on a pump truck.

FIG. 10 shows a side view of the connector of the hot-swap system according to the present invention hanging from a support structure mounted on a pump truck.

### DETAILED DESCRIPTION OF THE INVENTION

Therefore, a first object of the present invention is to provide a hot-swap system for a fracturing system that is simple and cost-effective in design, and that allows for a reliable connection to the main manifold or fracturing missile. Said hot-swap system has been particularly designed to advantageously:
I—Allow automatic interconnection of the fracturing pump to the fracture missile, without the need for operator intervention.

II—Support a maximum working pressure (MWP) of up to 15,000 psi.

III—Operate within an operating temperature range of −40° F. (−40° C.) to 140° F. (60° C.).

IV—Be configured to allow connection integrity testing, reducing the likelihood of failures.

V—Provide ease of replacement or repair of the components thereof.

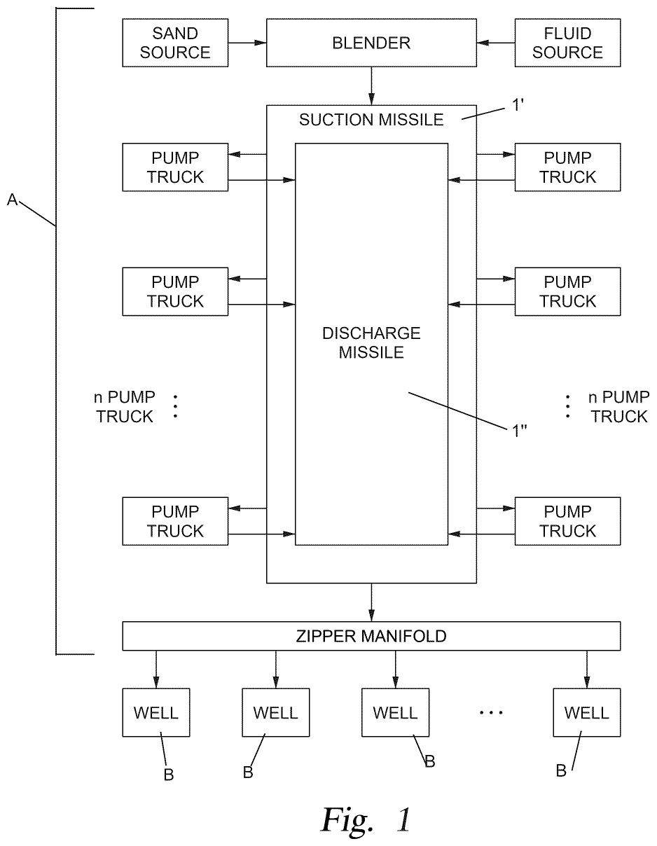

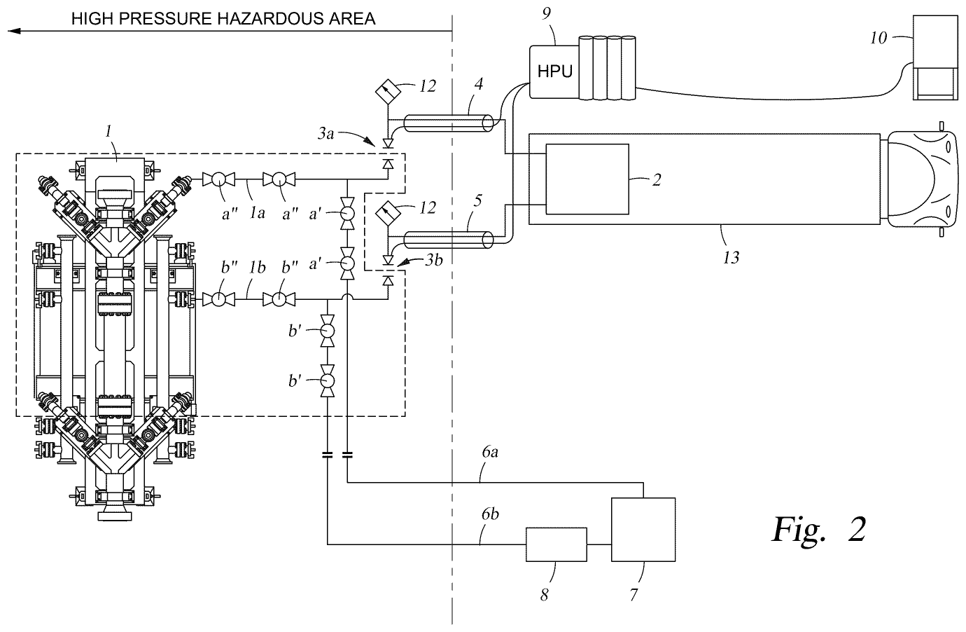

Referring to FIGS. 1 and 2, there is shown a schematic view of a hydraulic fracturing system that includes the hot-swap system according to the present invention.

Referring to FIG. 1, a typical arrangement of a hydraulic fracturing system A for hydraulically fracturing a plurality of wells B is shown. The hydraulic fracturing system A includes a blender adapted to mix fluid from a fluid source with sand from a sand source to produce a hydraulic fracturing fluid; a suction missile 1′ adapted to receive the hydraulic fracturing fluid from the blender, a discharge missile, a set of automatic connectors adapted to communicate the ^{hydraulic} fracturing fluid from the suction missile 1′ to a corresponding pump truck and, after pressurization by the corresponding pump truck, to communicate the corresponding pump truck with the discharge missile 1″; and a zipper manifold adapted to convey pressurized hydraulic fracturing fluid from the discharge missile 1″ to a plurality of wells B.

The hot-swap system according to the present invention comprises, as shown in FIG. 2, a main missile or manifold 1, which includes a high-pressure line 1a and a low-pressure line 1b, at least one pump truck 13 comprising a fracturing pump 2 in fluid communication with the high-pressure line 1a of said missile 1 through a discharge duct 4 comprising an automatic connector 3a and in fluid communication with the low-pressure line 1b of said missile 1 through a suction duct 5 comprising an automatic connector 3b.

In one embodiment, the fracturing pump 2 is connected to a priming tank 7 (primer) through a duct 6a, said priming tank 7 is in fluid communication with a priming pump 8, and said priming pump 8 is in fluid communication with the fracturing pump 2 through a priming duct 6b. Both ducts, 6a, 6b, comprise a plurality of valves a′ and b′ actuated by the hydraulic power unit 9 under the control of a remote control and actuation unit 10.

Said fracturing pump 2 is connected to the high pressure line 1a of the missile 1 through a discharge duct 4 and said high pressure line 1a comprises a plurality of actuated valves a″.

Furthermore, said fracturing pump 2 is connected to the low pressure line 1b of the missile 1 through the suction duct 5 and said low pressure line 1b comprises a plurality of actuated valves b″.

Preferably, said plurality of valves comprise operating valves and bleed valves.

Each high pressure line 1a and low pressure line 1b of the missile 1 has connection pins 11a, 11b and each discharge duct 4 and suction duct 5 comprises respective automatic connectors 3a, 3b actuated by the hydraulic power unit 9 in communication with the control and actuation unit 10.

At the start of the operation, fracturing pump 2 needs to be primed, for which at least one priming tank 7 is provided, supplying fracturing fluid in fluid communication with said fracturing pump 2 through a priming duct 6a comprising a priming valve assembly a′.

Said priming tank 7 supplies fracturing fluid to a priming pump 8 which pressurizes the fracturing fluid and sends it to the fracturing pump 2 through a priming duct 6b comprising a set of actuated valves b′.

In the priming operation (prime-up) of a fracturing pump, the priming valves a′, b′ on ducts 6a and 6b, respectively, remain open, while valves a″ on the high-pressure line 1a and valve b″ on the low-pressure line 1b remain closed, a pressure sensor 12 monitors the pressure in the suction duct 5 and discharge duct 4 of the fracturing pump 2, when it reaches the set pressure level, the priming valves a′, b′ are closed, and the discharge valve a″ and the suction valve b″ are opened to connect the fracturing pump 2 to the suction missile 1′ on one side and to the discharge missile 1″ on the other, initiating the fracturing fluid injection process.

Each set of valves a′, a″, b′ and b″ are actuated by a hydraulic power unit 9 which is connected to a remote control and actuation unit 10. Said valves a′, a″ are preferably plug-type valves (high-pressure line 1a) and valves b′, b″ are ball valves (low-pressure line 1b).

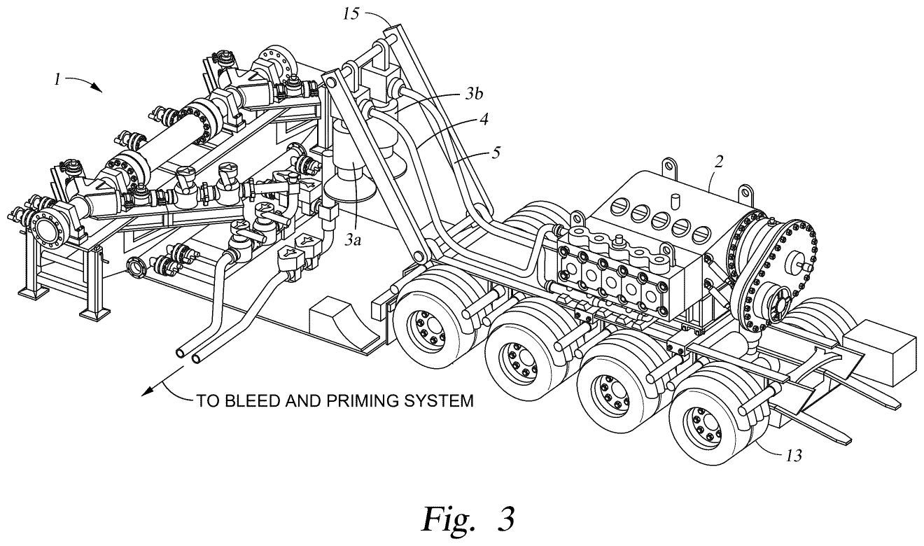

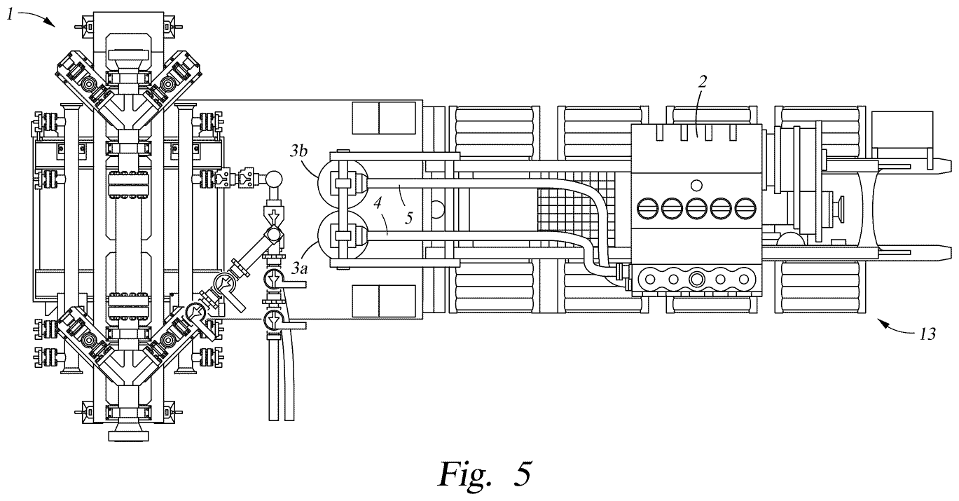

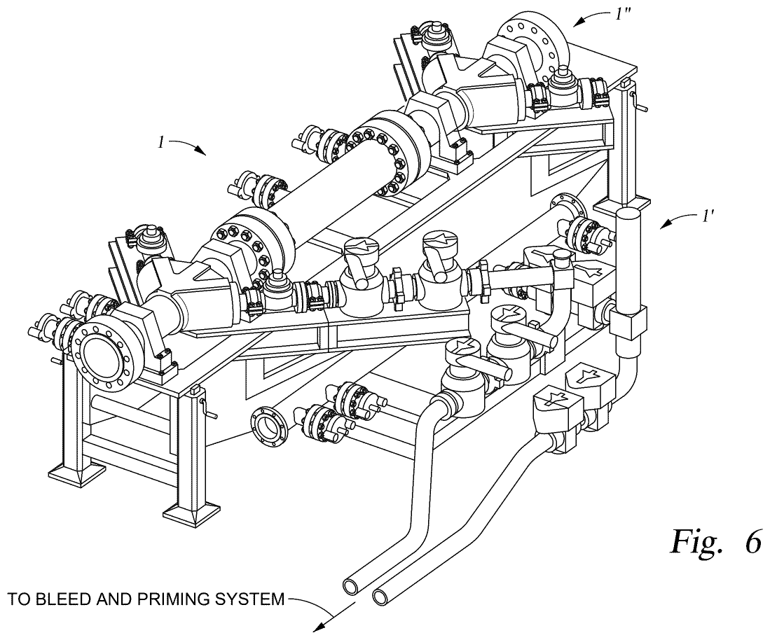

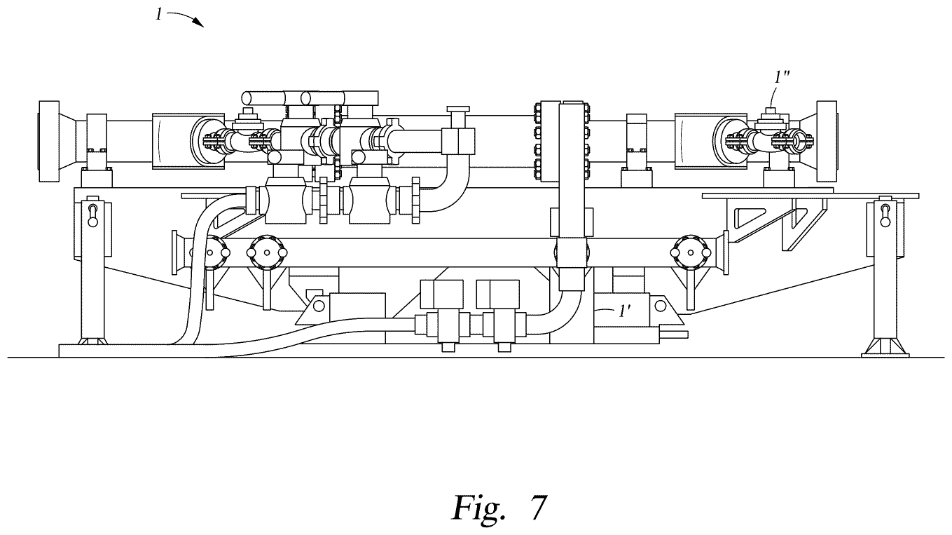

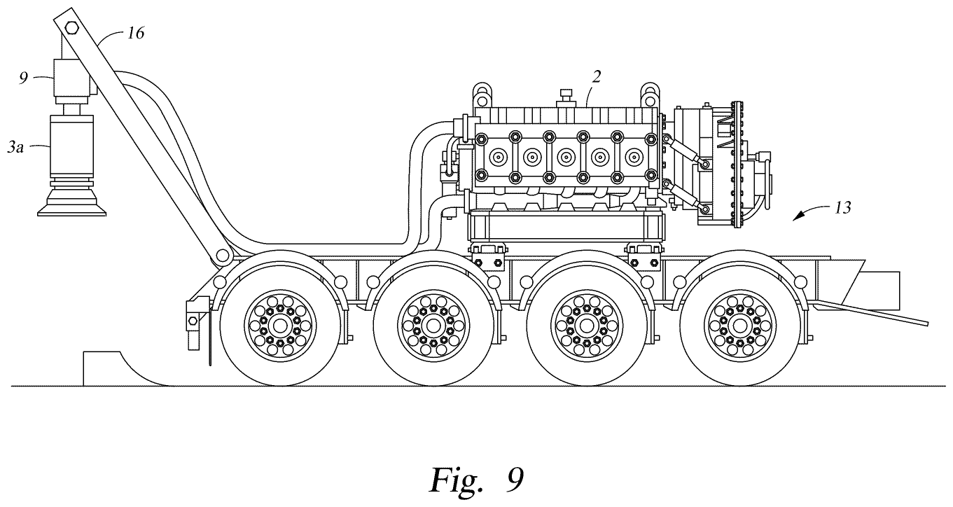

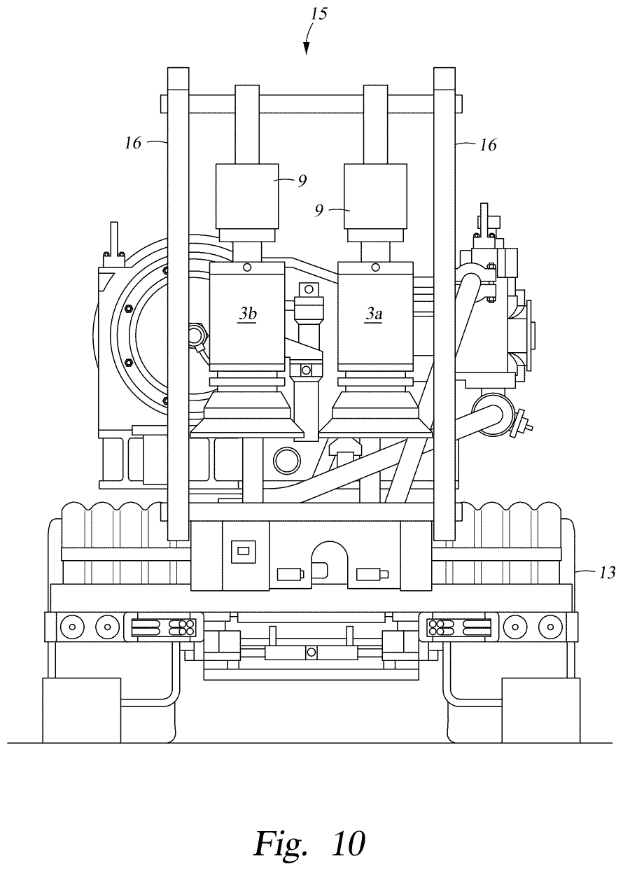

The fracturing pump 2 is preferably installed on a pump truck 13 as shown in FIGS. 3 to 10.

The hot-swap system according to the present invention was developed to allow the replacement of a fracturing pump in the hydraulic fracturing system without the need to stop the fracturing operation while other pumps are operational.

As already indicated, the fracturing pumps 2 are installed on trucks specially designed for these operations and according to FIG. 1, they can include a plurality of pump trucks arranged on both sides of missile 1.

Said fracturing pumps 2 are connected to two main lines: a high-pressure line, and a low-pressure line. The low-pressure line connects the fracturing pump 2 to at least one fracturing fluid mixer tank, with the connection between the fracturing pump 2 and the suction line being made by means of a suction duct 5 comprising an automatic connector 3b; in turn, the high-pressure line connects the fracturing pump 2 to the discharge missile 1″ through a discharge duct 4 comprising an automatic actuator 3a. Said discharge missile 1″ conducts the pressurized fracturing fluid towards a zipper manifold, whose function is to distribute the fracturing fluid between a plurality of wells B (see FIG. 1).

Each automatic connector 3a, 3b is connected to a respective connection pin 11a present on the suction missile 1′ and to a connection pin 11b present on the discharge missile 1″, respectively.

Basically, the hot-swap system establishes the connection between the respective fracturing pumps 2 and the missile 1 automatically, without the need for operator intervention. With this arrangement, it is possible to continue high-pressure pumping and perform the pump change without interrupting the process, while avoiding human presence in the hazardous area.

According to the present invention, the hot-swap system has been designed so that there is no need to clean the connector, thus eliminating the requirement for an operator to enter the high-pressure hazardous area.

These objectives are achieved by a quick-connect system comprising essentially two main components:
1—Automatic connectors 3a, 3b actuated by a hydraulic power unit 9 in communication with a remote control and actuation unit 10, and
2—Connection pins 11a, 11b forming part of missile 1.
   In a preferred embodiment, valves a″, b″ are operating and bleed valves (FIG. 2), and connection pins 11a, 11b form part of missile 1.

In another preferred embodiment, the hydraulic power unit is installed on the pump truck 13 carrying the fracturing pump 2.

The automatic connector 3a, 3b is a hydraulic type connector actuated by the hydraulic power unit 9 under the control of the remote control unit 10, which allows the fracturing pump 2 to be connected to the high and low pressure lines quickly and safely without the need for human presence in the danger zone.

In a preferred embodiment, the automatic connectors 3a, 3b include a main body housing a hydraulic piston (not shown) acting on a deformable slip that, when compressed by the action of the piston, elastically deforms to securely attach to a connection pin 11a, 11b. The automatic connector 3a, 3b has a main body with a securing end and a connection end, said connection end comprising a guide collar 14 that facilitates the alignment and connection operation of the automatic connector 3a, 3b with the connection pin 11a, 11b.

This automatic connector 3a, 3b allows for greater safety and efficiency in fracturing processes. This tool provides an average reduction in connection time per well at each stage of the fracturing procedure, reducing personnel exposure to high-pressure operations, and consequently increasing worker safety.

The connection pin 11a, 11b comprises a main body and a connection end with a profile designed to engage with the deformable slip of the automatic connector 3a, 3b.

Once the automatic connector reaches its correct connection position with the respective connection pin, the coupling stage begins through the activation of the respective slip.

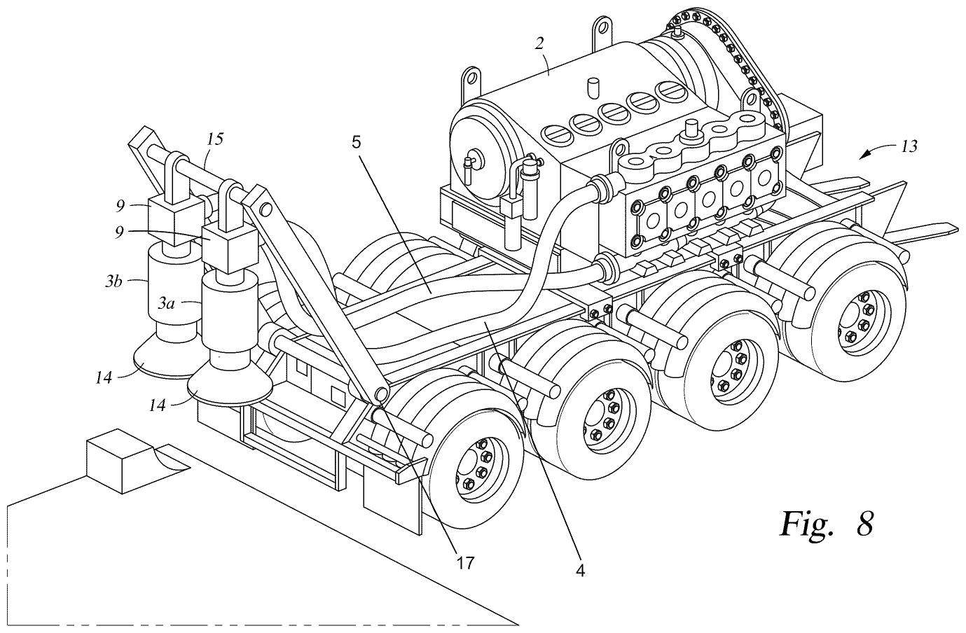

In the preferred embodiment shown in FIGS. 8, 9 and 10, pump truck 13 comprises a fracturing pump 2 connected to suction duct 5 adapted to connect to the low-pressure line of missile 1 and a discharge duct 4 adapted to connect to the high-pressure line of missile 1. Suction duct 5 has a connector 3b adapted in fluid communication with the low-pressure line, and discharge duct 4 has a connector 3a adapted in fluid communication with the high-pressure line of missile 1.

Each automatic connector 3a, 3b comprises a main body with a securing end, with the automatic connector 3a, 3b being hung by this securing end from a support structure 15 mounted on the truck chassis 13 using an appropriate hoisting system.

Preferably, the support structure 15 comprises at least one support arm 16 attached to the chassis of the pump truck 13.

In a preferred embodiment, the support arm 16 is pivotally attached to the support structure 15, allowing it to rotate about a pivot point 17 between an operational position and a non-operational position.

In another preferred embodiment of the invention, the support arm 16 is telescopically extendable, allowing the distance between the automatic connectors 3a and 3b and the truck chassis 13 to be adjusted.

In another preferred embodiment, the support structure 15 comprises a slidable support structure, which allows lateral or longitudinal movements with respect to the axial axis of the truck. Preferably, the slidable structure comprises bearings mounted on rails secured to the structure of the truck chassis 13. Said slidable support structure can be operated through controls located on the pump truck 13 or operated by a remote control unit.

In this way, during the coupling operation of connectors 3a, 3b to the respective connection pins 11 of fracturing missile 1, several degrees of freedom are achieved to ensure a precise coupling of the same.

### Operating Procedure

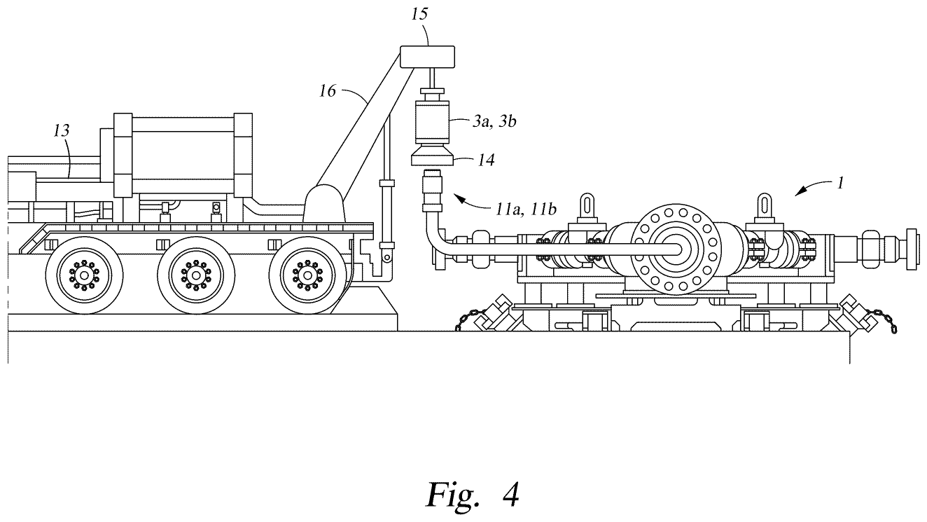

Truck 13 enters the interconnection zone. Once automatic connectors 3a, 3b are correctly aligned with connection pins 11a, 11b located on missile 1 (see FIG. 4), the coupling operation is executed by the actuation of the hydraulic power unit 9 under the control of the control and actuation unit 10. As indicated above, hydraulic power unit 9 is installed on the truck chassis, while the control and actuation unit 10 is preferably located adjacent to the driver's side of truck 13. In another preferred embodiment, the remote control and actuation unit 10 can be configured as a mobile device such as a smart phone.

The alignment of connectors 3a, 3b can be assisted by a conveniently located camera. Once connectors 3a, 3b are correctly aligned with the connection pins 11a, 11b, connectors 3a, 3b begin to lower into the respective connection pin mating position. Upon confirmation of correct socket alignment, the locking process of connectors to the respective connection pins begins.

Once locking is confirmed, the main seal integrity test is performed from the remote control and actuation unit 10.

Once the test is complete, standard pumping operations continue.

1. A hot-swap system, comprising:
a missile (1) comprising a high-pressure line (1a) with at least one connection pin (11a) and a low-pressure line (1b) with at least one connection pin (11b),
at least one fracturing pump (2), said fracturing pump (2) being connected in fluid communication to said high-pressure line (1a) by means of at least one automatic connector (3a) and to said low-pressure line (1b) by means of at least one automatic connector (3b), and
wherein said at least one automatic connector (3a), (3b) is configured to be connected to said at least one respective connection pin (11a) (11b).

2. A hot-swap system according to claim 1, characterized in that said at least one fracturing pump (2) is connected in fluid communication to said high-pressure line (1a) by means of at least one automatic connector (3a) present in a discharge duct (4), and to said low-pressure line (1b) by means of at least one automatic connector (3b) present in a suction duct (5).

3. The hot-swap system according to claim 1, characterized in that said fracturing pump (2) is additionally connected to a priming tank (7) by means of a priming duct (6a), where said priming tank (7) is in fluid communication with a priming pump (8).

4. The hot-swap system according to claim 3, characterized in that said priming pump (8) is connected in fluid communication to fracturing pump (2) through a priming duct (6b).

5. The hot-swap system according to claim 4, characterized in that said priming ducts (6a), (6b) comprise a plurality of valves (a′, b′).

6. The hot-swap system according to one claim 5, characterized in that said high-pressure line (1a) of missile (1) comprises a plurality of actuated valves (a″), and said low-pressure line (1b) of missile (1) comprises a plurality of actuated valves (b″).

7. The hot-swap system according to claim 6, characterized in that said plurality of valves (a′, a″, b′, b″) comprise operating valves and bleed valves.

8. The hot-swap system according to claim 1, characterized in that it further comprises a hydraulic power unit (9) in communication with a remote control and actuation unit (10).

9. The hot-swap system according to claim 8, characterized in that said at least one automatic connector (3a, 3b) is actuated by the hydraulic power unit (9) in communication with a control and actuation unit (10).

10. The hot-swap system according to claim 1, characterized in that the fracturing pump (2) is installed on a pump truck (13).

11. The hot-swap system according to claim 1, characterized in that said at least one connection pin (11a) is present on a suction missile (1′) and said at least one discharge pin (11b) is present on a discharge missile (1″).

12. The hot-swap system according to claim 11, characterized in that the hydraulic power unit (9) is installed on the pump truck (13).

13. The hot-swap system according to claim 1, characterized in that the at least one automatic connector (3a), (3b) comprises a main body with a securing end and a connection end, said main body being configured to house a hydraulic piston and a deformable slip.

14. The hot-swap system according to claim 13, characterized in that said connection end comprises a guide collar (14) for aligning and connecting the at least one automatic connector (3a), (3b) to the respective connection pin (11a), (11b).

15. The hot-swap system according to claim 13, characterized in that the at least one automatic connector (3a), (3b) is hung by its securing end to a support structure (15) mounted on the truck chassis (13) by a hoisting system.

16. The hot-swap system according to claim 14, characterized in that the support structure (15) comprises at least one support arm (16) attached to the pump truck chassis (13).

17. The hot-swap system according to claim 16, characterized in that the support arm (16) is pivotally attached to the support structure (15) and is configured to rotate between an operational position and a non-operational position.

18. The hot-swap system according to claim 16, characterized in that the support arm (16) is telescopically extendable to modify the distance between the automatic connectors (3a and 3b) and the truck chassis (13).

19. The hot-swap system according to claim 15, characterized in that the support structure (15) comprises a slidable support structure, configured to perform lateral or longitudinal movements relative to the axial axis of the truck (13).

20. The hot-swap system according to claim 19, characterized in that the slidable structure comprises bearings mounted on rails secured on the structure of the truck chassis (13).

21. The hot-swap system according to claim 20, characterized in that said slidable support structure can be operated through controls located on the pump truck (13) or operated by a remote control unit.

22. The hot-swap system according to claim 1, characterized in that the connection pins (11a, 11b) each comprise a main body and a connection end with a profile configured to engage the deformable slip of the respective automatic connector (3a, 3b).
